(19) United States
(12) Patent Application Publication
(10) Pub. No.: US 2025/0051956 A1
(43) Pub. Date: Feb. 13, 2025

(54) INTERNAL SURFACE ELECTROCHEMICAL TREATMENT ELECTRODE

(71) Applicant: 3DM BIOMEDICAL PTY LTD, Moruya, New South Wales (AU)

(72) Inventor: Dean KLOWER, Moruya (AU)

(73) Assignee: 3DM BIOMEDICAL PTY LTD, Moruya, New South Wales (AU)

(21) Appl. No.: 18/720,156

(22) PCT Filed: Dec. 8, 2022
(86) PCT No.: PCT/AU2022/051472

§ 371 Date: Jun. 14, 2024

(30) Foreign Application Priority Data
Dec. 16, 2021 (AU) 2021904085

(51) Int. Cl. C25F 7/00; B33Y 40/20; C25F 3/16

(52) U.S. Cl. CPC C25F 7/00; B33Y 40/20; C25F 3/16

(57) ABSTRACT

An electrochemical treatment electrode configured to contact an internal surface of metallic article with an electrochemical treatment fluid, the electrode comprising: a flexible conducting body; and a plurality of flexible elements connected to and extending generally outwardly of the flexible conducting body which are configured to locate an electrochemical treatment fluid around the flexible conducting body, wherein the plurality of flexible elements includes a plurality of conductive fibres or non-conductive fibres extending generally outwardly of the flexible conducting body, the plurality of conductive fibres or non-conductive fibres configured to contact the internal surface of the metallic article when the electrode is in use.

### PRIORITY CROSS-REFERENCE

The present application claims priority from Australian provisional patent application No. 2021904085 filed on 16 Dec. 2021, the contents of which are to be understood to be incorporated into this specification by this reference.

### TECHNICAL FIELD

The present invention generally relates to an electrochemical treatment electrode configured to electrochemically treat and/or process an inner or internal surface of a metallic object and an associated electrochemical treatment apparatus and method. The invention is particularly applicable to electrochemical treating, and in particular electropolishing metal alloys that are additively manufactured (3D printed) and it will be convenient to hereinafter disclose the invention in relation to that exemplary application. However, it should be appreciated that the invention is not specifically limited to additively manufactured (3D printed) metal and metal alloy products and can be applied to a wide variety of metallic (metal and metal alloy) articles produced from a variety of manufacturing methods that require electrochemical treatment of an internal or inner surface of that metallic article.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Additive manufacturing of metallic articles provides significant freedom in design and configurations. A number of techniques are now available to 3D print metallic articles including electron beam melting (EBM), direct metal laser sintering (DMLS), selective heat sintering (SHS), and selective laser melting (SLM). However, many of these additive manufacturing techniques produce articles that have surfaces with a high surface roughness that require finishing.

Electrochemical treatment techniques can be used to selectively treat surfaces. For example, electropolishing techniques can be used to reduce the surface roughness of such 3D printed surfaces. One suitable electropolishing system is taught in International Patent Publication No. WO2020/206492. Whilst this electropolishing system can use conventional electrodes to electropolish the outer surfaces of a 3D printed metallic article, the internal surfaces can be problematic due to the size, shape and inaccessibility of those internal surfaces. This issue can be exacerbated by the design freedom additive manufacturing provides, with more complex internal structures and such as cavities, hollows, channels or apertures being incorporated into 3D printed designs. Finishing of these types of internal galleries can therefore be extremely problematic.

Similar issues in properly treating and processing internal structures and such as cavities, hollows, channels or apertures are encountered with other electrochemical treatment processes such as electro cleaning, anodising, Parkerizing and pickling.

It would therefore be desirable to provide an alternate or improved electrode configured to electrochemically treat the internal surface/internal galleries of a metallic article having an internal cavity, space, hollow, channel or aperture.

### SUMMARY OF THE INVENTION

The present invention provides an electrode configured to electrochemically treat the internal surfaces of cavities, hollows, channels or apertures therein within metallic articles or products such as heat exchangers, engine parts or the like. That electrochemical treatment can be any electrochemical process in which a power supply (AC or DC) is used to treat a surface. Suitable electrochemical treatment processes include electropolishing, electro cleaning, anodising, Parkerizing and pickling. In various embodiments, the present invention is particularly applicable for electropolishing internal surfaces of metal parts, for example additively manufactured (3D printed) metal parts.

A first aspect of the present invention provides an electrochemical treatment electrode configured to contact an internal surface of metallic article with an electrochemical treatment fluid, the electrode comprising:
a flexible conducting body; and
a plurality of flexible elements connected to and extending generally outwardly, preferably generally radially outwardly, of the flexible conducting body which are configured to locate an electrochemical treatment fluid around the flexible conducting body,
wherein the plurality of flexible elements includes a plurality of conductive or non-conductive fibres extending generally outwardly of the flexible conducting body, the plurality of conductive or non-conductive fibres configured to contact the internal surface of the metallic article when the electrode is in use.

The electrode of this first aspect comprises a flexible conducting body, on or to which the flexible elements, including the plurality of conductive or non-conductive fibres, are connected and extend. The flexible conducting body generally extends along an axial axis, with the plurality of flexible elements extending generally outwardly, preferably generally radially outwardly, of the flexible conducting body and axis thereof. The flexible elements are designed to be flexible enough to resiliently deform so that the electrode can be inserted into and moved through cavities, hollows, channels or apertures within metallic articles, for example additively manufactured metallic articles. The plurality of flexible elements, preferably multiple flexible elements, are used to retain an electrochemical treatment fluid, such as an electrolyte, around the conductive body, to enable the electrolyte to conduct a current therethrough to facilitate electrochemical treatment of the internal surface within the cavity, hollow, channel or aperture within the metallic article being electrochemically treated. More particularly, the plurality of flexible elements retains the electrochemical treatment fluid, such as an electrolyte, around the conductive body when within the hollow, channel or aperture within the metallic article being electrochemically treated. The flexibility of the flexible elements enables the electrode to be inserted within an internal cavity, space, hollow, channel or aperture of a metallic article, and then pass in and around contours, projections or other features therein whist still locating/retaining the electrochemical treatment fluid around the flexible conducting body.

The flexible elements also act to space the flexible conductive body away from the surface of a metallic article that is being electrochemically treated. Current for electrochemically treatment of the surface is provided through the flexible conductive body and then through an electrochemical treatment fluid, for example an electrolyte, that is present in the electrode and on that surface. Where the flexible elements are non-conductive, these assist in this spacing function. Where the flexible elements are conductive, these can assist in that transfer of current from the flexible conductive body to the electrolyte and then to the treatment surface/surfaces. Where there is a mixture of non-conductive and conductive elements (for example fibres or bristles-see below), the non-conductive elements are typically longer than the conductive elements to assist spacing the conductive elements away from the treatment surface.

Again, it should be appreciated that the electrochemical treatment of the present invention can be any electrochemical process in which a power supply (AC or DC) is used to treat a surface. Suitable electrochemical treatment processes include electropolishing, electro cleaning, anodising, Parkerizing and pickling.

In various embodiments, the present invention is particularly applicable for electropolishing internal surfaces of metal parts, for example additively manufactured (3D printed) metal parts. The electrode particularly works well with the electropolishing system of the Applicant taught in International Patent Publication No. WO2020/206492 the contents of which should be understood to be incorporated into this specification by this reference. When used in the electropolishing system of WO2020/206492, the wire can be designed to carry the large currents required and the enamel (wire coating) melting point can be managed by duty cycle and rest/cooling time.

The plurality of flexible elements extends generally outwardly, preferably generally radially outwardly, of the flexible conducting body. The flexible elements are preferably resilient—i.e., have some mechanical memory—to allow each flexible conductor to bend, twist or otherwise deform and then restore back to its original extended state. This allows the electrode to be inserted in and around contours, projections or other features within the cavity (for example a small flange) and then expand to electrochemically treat a larger gallery within.

The electrochemical treatment fluid can be any fluid used in the electrochemical treatment process. The electrochemical treatment fluid is preferably a conductive fluid. For example, where the electrode is used for electropolishing, an electropolishing electrolyte can be used. The electropolishing electrolyte can be any suitable conductive liquid as described in more detail below.

The flexible elements can comprise any suitable flexible strip, fibre or the like. In some embodiments, the flexible elements comprise a plurality of wires, strips, cords, filaments, hairs, spines, fibres, whiskers or bristles.

The flexible elements can comprise conductive elements, non-conductive elements, or a mixture thereof. In particular embodiments, at least some of the flexible elements comprise a plurality of flexible conductive elements, preferably conductive fibres. A variety of fibres can be used. In embodiments, the plurality of conductive or non-conductive fibres may include conductive fibres that comprise a plurality of carbon fibres, metallic fibres or a mixture thereof. It should be appreciated that any suitable high temperature conducting fibre could be used. In some embodiments, some or all of the flexible elements comprise a plurality of non-conductive elements such as fibres. Examples of non-conductive fibres include at least one of fiberglass, polyparaphenylene terephthalamide (Kevlar) or a mixture thereof. It should be appreciated that any suitable high temperature non-conducting fibre could be used. In embodiments, the plurality of conductive fibres or non-conductive fibres include a plurality of non-conductive fibres that comprise at least one of fiberglass, polyparaphenylene terephthalamide (Kevlar), or a mixture thereof. In some embodiments, the flexible elements can comprise one of conductive fibres or non-conductive fibres. In some embodiments, the flexible elements comprise a mixture of conductive and non-conductive fibres/elements.

In exemplarity embodiments, the flexible elements include a plurality of carbon fibres. One example of suitable carbon fibre comprises unidirectional 450 gsm Carbon fibre.

In exemplarity embodiments, the flexible elements include a plurality of fibreglass fibres. One example of suitable fibreglass comprises unidirectional 250 gsm fibreglass.

In exemplarity embodiments, the flexible elements comprise a plurality of Kevlar (polyparaphenylene terephthalamide) fibres. One example of suitable Kevlar fibres comprises unidirectional 3.2 or Arimid (polyparaphenylene terephthalamide-Kevlar)

The dimensions of the flexible elements are typically configured to suit the dimensions of the channel or duct of the metallic article that is subject to electrochemical treatment. In some embodiments, the flexible elements are sized to extend to, more preferably proximate to (but not touching) the internal surface to be treated. For example, the length of each flexible conductor is typically selected to have a complementary length to the radial size of the channel or duct. In some embodiments, the internal surface is part of a channel or duct having a diameter between 2 mm to 5 m. In some embodiments, the channel or duct can have a diameter from 0.5 to 5 m, for example a pipe, pipeline such as an oil or gas pipeline or the like. In some embodiments, the internal surface is part of a channel or duct having a diameter between 2 to 20 mm, preferably between 4 to 10 mm, more preferably from 4 to 8 mm. However, it should be appreciated that the process could be done down to the width of a fibre. In other embodiments, the length of the flexible elements is sized to substantially match the radius of the channel or duct of the metallic article that is subject to electrochemical treatment. Here, the length of the flexible elements is typically similar or slightly larger than the radius of the channel or duct.

It is important to note that the flexible elements, and in particular the plurality of conductive or non-conductive fibres are configured to contact the internal surface of the metallic article when the electrode is in use. The electrode of the present invention therefore is not required to be electrically isolated from the workpiece during operation. The flexible elements, such as the plurality of conductive or non-conductive fibres are configured to be able to contact the internal surface of the metallic article/workpiece in operation i.e. when electrochemically treating an internal surface of a metallic article.

It should be appreciated that the internal size/diameter of the channel or duct of the metallic article may not be constant, and therefore the length of each flexible element is designed to fit the largest diameter or in some cases the substantive/main diameter, and movement and flexibility of the flexible element can be used to electrochemically treat surfaces in the channel or duct of the metallic article of different sizes/diameters.

The flexible elements do not need to have a uniform length extending outwardly of the conducting body. The flexible elements need not have the same length around the circumference of the flexible conducting body or have the same length along the axial length of the flexible conducting body.

In embodiments, the flexible elements can have different lengths about the conducting body. For example, where there is a mixture of non-conductive and conductive elements (such fibres or bristles), the non-conductive elements are typically longer than the conductive elements to assist spacing the conductive elements away from the treatment surface. In some embodiments, a first set of flexible elements, for example conductive elements such as carbon fibre, have a shorter length than a second set of flexible elements, for example non-conductive fibres, such fibre glass or polyparaphenylene terephthalamide (Kevlar) fibres. Again, the longer fibre glass/Kevlar fibres ensure that the shorter carbon fibres are suitable spaced away from the surface to be electrochemically treated to reduce spark or short circuit events.

In some embodiments, the length, preferably the radial length of the flexible elements may vary around the circumference of the conducting body. Here, a first section or segment around the around the circumference of the conducting body may have a longer length than a second section or segment around the around the circumference of the conducting body. That length may be configured to match the shape or configuration of a particular cavity or internal opening that the electrode is configured to electrochemically treat. This can provide an electrode with a shaped radial cross-section such as shaped as a regular or irregular polygon or the like. Examples include triangles, trapeziums, hexagons of the like.

The flexible elements can be connected to the flexible conducting body using any suitable attachment means or configuration. For example, the flexible elements may be connected to the flexible conducting body through compressive engagement, weaving, adhesion, welding, embedding, wedging, implanting, bonded, anchoring or a combination thereof. Compressive engagement can take various forms. In some embodiments, the flexible elements are clamped, crimped, pressed or tied into connection with the flexible conducting body.

In particular embodiments, the elongate flexible conducting body comprises at least two elongate wires twisted or otherwise intertwined, and the flexible elements are connected to the flexible conducting body through compressive engagement between the at least two elongate wires. The use of twisted wires enables the flexible elements to be quickly fixed between the two wires when forming/manufacturing the electrode. In other embodiments, the flexible elements are held in a spring. In such embodiments, the elongate flexible conducting body comprise at least one extension spring, and the flexible elements are connected to the flexible conducting body through compressive engagement between adjacent coils of the spring. In yet other embodiments, the flexible elements are soldered, welded or glued to the flexible conducting body. In yet other embodiments, the flexible elements are pressed or crimped to the flexible conducting body.

The electrode may include further features in addition to the flexible elements to assist in electrochemically treating the subject internal surface of the metallic article.

In embodiments of the electrode of the first aspect, the flexible elements include and/or comprise at least one flexible sheet or body. In some embodiments, the electrode further comprises at least one flexible sheet or body, connected to the flexible conducting body preferably extending from, or positioned proximate to, between and/or around the plurality of flexible elements. In some embodiments, the flexible sheet or body comprises the flexible elements connected to and extending generally outwardly of the flexible conducting body which are configured to locate an electrochemical treatment fluid around the flexible conducting body.

In particular embodiments of the present invention, the electrochemical treatment electrode is configured to contact an internal surface of metallic article with an electrochemical treatment fluid, the electrode comprising:
a flexible conducting body; and
a plurality of flexible elements connected to and extending generally outwardly of the flexible conducting body which are configured to locate an electrochemical treatment fluid around the flexible conducting body,
wherein the flexible elements include at least one flexible sheet or body; or
the electrode further comprises at least one flexible sheet or body, connected to the flexible conducting body preferably extending from, or positioned proximate to, between and/or around the plurality of flexible elements.

The flexible sheet or body is typically formed with, positioned proximate to, within, and/or surrounded by the flexible elements and acts as both an additional conductor and in some instances an adsorbent body for carrying any electrochemical treatment fluid such as an electrolyte used in the electrochemical treatment procedure. Any suitable flexible sheet or body can be used, for example one or more foam, sponge or fabric material. Where the flexible sheet/body comprises a foam, any suitable foam can be used, for example a natural or polymer foam. In embodiments, the foam comprises a high temperature foam, such as Intek® PFI-1120 high-temperature foam. Similarly, any suitable fabric material can be used, including woven, unwoven material. In embodiments the fabric comprises a high temperature fabric, such as a fibreglass based fabric, carbon fibre based fabric, or ZOPIN 1.0 g/cm³. The flexible sheet is used to carry electrochemical treatment fluid and can be preferably conductive to assist in the electrochemical treatment of said internal surface of the metallic article depending on the metal to be treated. For example, the flexible sheet can be conductive for nickel alloys. In other embodiments, the flexible sheet can be non-conductive, for example for aluminium alloys. In one embodiment, the flexible sheet or body comprises a foam element configured extend over and surrounding the electrode and plurality of flexible elements. The foam element preferably comprises a sheath or other encompassing body that extends around the electrode and plurality of flexible elements. The plurality of flexible elements can preferably extend into the foam material, thereby providing an electrically conductive path/element within the foam material. However, it should be appreciated that the flexible sheet or body could be configured extend over and surround the electrode using various other means that could connect or otherwise locate the flexible sheet or body around the flexible conducting body.

In some embodiments, the electrode further comprises a plurality of conductive particles located proximate to and/or between the plurality of flexible elements. The conductive particles provide an additional conductor means that can mix within the electrochemical treatment fluid, for example an electrolyte, to add further contact points with the internal surface to be electrochemically treated within the cavity.

The flexible conducting body can comprise any suitable flexible body onto which the flexible elements can be connected.

In many embodiments, the flexible conducting body comprises an elongate flexible conducting body, such as a wire, that defines a longitudinal axis along the length thereof. The flexible elements are therefore electrically connected to and extend generally outwardly, preferably generally radially outwardly of the longitudinal axis of the flexible conducting body. In these embodiments, the conducting body preferably comprises a metallic wire, and more preferably a magnet wire. In other embodiments, the conducting body comprises a carbon fibre wire or elongate body. However, it should be appreciated that any conductive metal could be used for the wire, for example stainless steel, gold, copper, aluminium or any other metal or conductive material which exhibits good conductivity and corrosion resistance.

Where the conducting body comprises a metallic wire or similar, that conducting body may include an insulative coating or sleeve over non-electrically connected surfaces. This insulative coating or sleeve may comprise a dielectric coating, preferably a polymer coating, more preferably an enamel or a urethane coating. A variety of dielectric coatings can be used on the wire. A number of conventional wire coating are suitable as these are already inert to most electrochemical treatment fluids, such as electropolishing electrolytes. It should be appreciated that where a coating or sleeve is unsuitable, that wire could be recoated with a suitable coating. In other embodiments, a suitable metal wire, such as a magnet wire could have a suitable dielectric coating or sleeve added, for example inert urethane or similar as required.

The conducting body does not necessarily comprise an elongate wire in all embodiments of the present invention. In some embodiments, the conducting body may comprise a flexible body, such as a sphere, ball, rod or pipe which include the flexible elements extending outwardly from the surface of that flexible body. That flexible body can be formed from any suitable flexible material such as foam, sponge, fabric or the like. That conducting body may include an internal cavity, and thus be hollow. In some embodiments, the conducting body comprises a sphere and the plurality of flexible elements comprise at least one rib, flange or strip which extends from the conducting body. In other embodiments, the flexible body comprises a sphere, ball, rod or pipe with the flexible elements comprising a plurality of flexible conductive fibres which extend outwardly from the surface of the flexible body. Those plurality of flexible conductive fibres can be connected to the flexible body using any suitable meaning including imbedding, adhesion, clasps, clips, crimping or the like.

A second aspect of the present invention provides an apparatus for electrochemically treating an internal surface of a metallic article comprising:
at least one electrochemical treatment electrode according to the first aspect of the present invention;
an electrochemical treatment fluid source configured to provide electrochemical treatment fluid to the flexible elements of the electrode and onto the internal surface of metallic article; and
a power source,
wherein the electrochemical treatment electrode is connected to a terminal of the power source and the metallic article is connected to the opposite terminal of the power source.

This second aspect of the present invention provides an electrochemical treatment apparatus that includes the electrochemical treatment electrode of the first aspect of the present invention. In this arrangement, the metallic article provides one electrode, for example the anode, of the electrochemical treatment circuit and the electrochemical treatment electrode of the first aspect of the present invention provides the other electrode, for example the cathode, to complete the electrical circuit. The electrochemical treatment fluid acts as a conductive medium around the conducting body of the electrode within the flexible elements of the electrode which facilitates electrochemical treatment of the selected surface.

Again, it should be appreciated that the electrochemical treatment of the present invention can be any electrochemical process in which a power supply (AC or DC) is used to treat a surface. Suitable electrochemical treatment processes include electropolishing, electro cleaning, anodising, Parkerizing and pickling.

The apparatus preferably further includes an electrochemical treatment fluid source configured to provide electrochemical treatment fluid to the flexible elements of the electrode and onto the internal surface of metallic article. The electrochemical treatment fluid, such as an electrolyte, is preferably fed onto at least the internal surface of metallic article. In embodiments, that electrochemical treatment fluid source can be a fluid pump or other fluid conveyer which feeds electrochemical treatment fluid to the electrode and onto the internal surface of metallic article. However, in some embodiments, that electrochemical treatment fluid source may be a reservoir in which the metallic article can be immersed, for example a container or other fluid holding receptacle which holds the electrochemical treatment fluid therein.

The electrochemical treatment fluid can be any fluid used in the electrochemical treatment process. The electrochemical treatment fluid is preferably a conductive fluid. For example, where the apparatus of this second aspect comprises an electropolishing apparatus, an electropolishing electrolyte can be used. The electropolishing electrolyte can be any suitable conductive liquid. In preferred forms the electropolishing electrolyte includes H₃PO₄. The electropolishing electrolyte preferably comprises a solution including phosphoric acid in solution based on water or a C₁-C₄ alcohol. The electropolishing electrolyte may comprise a solution of phosphoric acid (H₃PO₄) as the sole component acid, or in combination with other chemicals, for example other acids. For example, embodiments of the electropolishing electrolyte may include phosphoric acid in combination with one or more of sulfuric acid (H₂SO₄), hydrochloric acid (HCl), and in combination with one or more of water or a C₁-C₄ alcohol. In one form, the electrolytic solution comprises an 85% aqueous solution of phosphoric acid. However, the composition depends on the ionic content and other variables including voltage, current and temperature of the electropolishing electrolyte.

In exemplary embodiments, the electropolishing electrolyte is a food-grade (safe) electrolyte bath. Any suitable conductive liquid could be used. In embodiments, the electropolishing electrolyte comprises phosphoric acid in combination with one of water or a C₁-C₄ alcohol. In embodiments, the electropolishing electrolyte comprises an aqueous phosphoric acid solution.

Solution concentrations of acid, in particular phosphoric acid, in the electrolyte may vary from 1% to 90% (i.e. 1 g to 90 g of compound in 100 ml of water), preferably from 10% to 90%. Solution concentration depends on type of metallic article to be treated (e.g. stainless steel, cobalt-chromium alloys, Ni—Cr alloys, aluminium or Al alloys, titanium or Ti alloys, or the like) and electrolytic treatment time. In one embodiment, 85% phosphoric acid solution is used.

The electrochemical treatment fluid can be applied to the internal surface of the subject metallic article from the electrochemical fluid source by any useful means. In some embodiments, the metallic article is immersed in the electrochemical treatment fluid. In some embodiments, the electrochemical treatment fluid is fed onto the internal surface through a pipe or conduit. In these embodiments, the apparatus may further include an electrochemical treatment fluid feed conduit including at least one fluid outlet located within the electrode. This enables the electrochemical treatment fluid to be fed proximate the electrode onto the internal surface of interest. The apparatus may also include a coolant conduit including at least one fluid outlet located within the electrode. Again, this enables coolant to be fed proximate the electrode onto the internal surface of interest. In embodiments, the solution for electrolyte or cooling fed into electrode via a conduit such as a silicone tube that is connected, preferably in parallel with flexible conducting body. For example, where the flexible conducting body comprises a spring, each conduit can be located in or down the center of the spring system.

The coolant and electrochemical treatment fluid can be pumped using any suitable fluid movement system, including (but not limited to) a pump, syringe, piston or similar. In some embodiments, the solution for electrochemical treatment fluid or cooling fed into channel or gallery with pump, syringe, piston or similar.

The electrochemical treatment electrode is typically drawn or otherwise moved through the cavity in the metallic article, to progressively electrochemically treat the internal surface therein. In many embodiments, this movement can be actuated or driven using a suitable draw apparatus for driving movement of the electrode over the internal surface of the metallic article. Examples of draw apparatus include linear actuators, winches or the like.

The electrochemical treatment power source or electrochemical treatment generator typically includes a suitable AC, DC or pulsed power supply (voltage or current controlled) is used to electrically connect both electrodes (i.e. the cathode/electrochemical treatment electrode and the anode/metallic article).

The specific current and current density used for the electrochemical treatment process depends on the particular application and treatment regime intended. It should be understood that a person skilled in the art would be able to apply the most suitable parameters based on the common general knowledge in the art related to that electrochemical treatment process.

The current can be DC only, AC only, square wave pulse DC, sinusoidal pulsed DC or a mixture thereof. Where a pulsed DC waveform is used it should be appreciated that the applied current waveform is not classic AC and not precisely DC. The waveform can be characterised as a square waveform current that is either an alternating current, or a pulsing DC square wave. In some embodiments, the pulsing DC square waveform has a longer zero current phase compared to the peak or applied current phase. In a number of embodiments, the current comprises a DC current.

The shaped waveform of the voltage can be one of square wave, sinusoidal, pulsed, or a combination thereof. In some embodiments, the shaped waveform current comprises a pulsed width modulation (PWM) waveform, preferably a square wave pulse, preferably having a variable dead time. In some embodiments, the square wave pulse has a variable dead time. In some embodiments, the pulsing square waveform has a longer zero current phase compared to the peak or applied voltage phase.

A third aspect of the present invention provides a method of electrochemically treating an internal surface of a metallic article comprising:
electrically connecting the electrochemical treatment electrode according to the first aspect of the present invention to a terminal of a power source;
electrically connecting the metallic article to the opposite terminal of the power source;
contacting at least the internal surface of metallic article with an electrochemical treatment fluid; and
moving the electrochemical treatment electrode across the internal surface of the metallic article whilst an electrochemical treatment current is applied between the terminals of the power source, wherein at least a portion of the plurality of conductive or non-conductive fibres contact the internal surface of the metallic article,
thereby electrochemically treating the internal surface.

This third aspect of the present invention provides a method of electrochemically treating a metallic article using the electrochemical treatment electrode of the first aspect. Again, it should be appreciated that the electrochemical treatment of the present invention can be any electrochemical process in which a power supply (AC or DC) is used to treat a surface. Suitable electrochemical treatment processes include electropolishing, electro cleaning, anodising, Parkerizing and pickling.

In particular embodiments, the third aspect of the present invention provides a method of electropolishing a metallic article using the electropolishing electrode of the first aspect. Here the method is one of electropolishing an internal surface of a metallic article, which comprises the steps of:
electrically connecting the electrochemical treatment electrode according to the first aspect of the present invention to the negative terminal of an electropolishing power source;
electrically connecting the metallic article to the positive terminal of the electropolishing power source;
contacting at least the internal surface of metallic article with an electropolishing electrolyte; and
moving the electrode across the internal surface of the metallic article whilst an electropolishing current is applied between the positive terminal and negative terminal, thereby electropolishing the internal surface.

This electropolishing technique can be applied to metallic articles with rough internal surfaces to achieve a reduction in surface roughness. Electropolishing aims at a resulting surface finish free of a heterogeneous texture and/or exhibiting a considerably lower surface roughness value compared to its initial surface roughness value. Suitable metrology methods to quantify surface roughness include surface stylus profilometry (from which Ra and Rz parameters are derived from a profile (line)) and 3D-optical surface profilometry (from which Sa and Sz parameters are derived from a surface area).

Any suitable metallic article can be treated using the electrochemical treatment method of this third aspect of the present invention comprises a large variety of metals. Examples include iron and iron containing alloys (for example tool steel H13, Carbon steel (common) and stainless steel), aluminium and aluminium containing alloys, titanium and titanium containing alloys, chromium and chromium containing alloys, copper alloys, brass alloys, Niobium. In some embodiments, suitable manufactured metallic articles to be treated in this invention can comprise a chromium containing metal alloy. As indicated previously, these alloys include iron-chromium alloys such as stainless steels, nickel-chromium (nickel-chrome) and its alloys, cobalt-chromium alloys, cobalt-chromium-molybdenum alloys. In preferred embodiments, the manufactured metallic article comprises a cobalt-chromium alloy.

In embodiments, the metallic article provides the anode of the electrochemical treatment circuit and the electrochemical treatment electrode of the first aspect of the present invention provides the cathode to complete the electrical circuit. The electrical connection to the electrochemical treatment electrode is typically via the flexible conducting body of the electrochemical treatment electrode, which is connected to the negative terminal of the power source. However, it should be appreciated that the polarity can be opposite for metal cleaning or Parkerizing.

The electrode is configured to electrochemically treat internal surfaces of cavities, hollows, channels or apertures therein within metallic articles or products. The internal cavity can have a variety of configurations. In this sense, the internal surface may comprise at least one surface of any one or more of a channel, hollow, cavity, aperture, opening, conduit, tunnel, duct, tube, pipe, ditch, slit, gully, chamber, furrow, vein, groove, trough, through hole, funnel, gutter or the like.

As discussed above, the flexible elements are preferably sized and configured for the shape and configuration of the internal cavity it is electrochemically treating. For example, where the internal surface is part of a channel or duct and the length of the flexible elements are selected to have a complementary length to the radial size of the channel or duct. That channel or duct can have any size. Again, the flexible elements need not have the same length around the circumference of the flexible conducting body, or have the same length along the axial length of the flexible conducting body.

It should be appreciated that the electrode can be configured to electrochemically treat an internal surface of any particular size of channel, hollow or cavity within the metallic article. In some embodiments, the internal surface is part of a channel or duct having a diameter between 2 mm to 5 m. In some embodiments, the channel or duct can have a diameter from 0.5 to 5 m, for example a pipe, pipeline such as an oil or gas pipeline or the like. In some embodiments, the internal surface is part of a channel or duct having a diameter between 2 to 20 mm, preferably between 4 to 10 mm, more preferably from 4 to 8 mm. In particular embodiments, internal channels down to 2 mm diameter and up to 8 mm have been electrochemically treated with electrodes made to suit the channel size. Again, it should be appreciated that the process could be done down to the width of a fibre.

The electrochemical treatment electrode is typically drawn or otherwise moved through the cavity in the metallic article, to progressively electrochemically treat the internal surface therein. In embodiments, the electrochemical treatment electrode is moved across the internal surface through pulling engagement of the flexible conducting body. The electrochemical treatment electrode is preferably in contact with or in close proximity to (i.e. proximate to) internal surface when moving across the internal surface of the metallic article. However, it should be appreciated that in some embodiments the electrode could be configured to be moved away from the surface during said movement, for example if the electrode was laterally moved, spun or otherwise manipulated within the cavity. Equally, electrochemical treatment is possible where the electrode and/or the flexible elements thereof are proximate to but not in direct contact with the internal surface/treatment surface. The electrolyte is used in these instances to provide the medium through which an electrical connection is formed between the electrode to the internal surface/treatment surface of the metallic article. Again, in many embodiments, the flexible elements, particularly non-conductive flexible elements, are used to space the flexible conductor body and (where applicable) conductive flexible elements away from the internal surface/treatment surface of the metallic article. The electrochemical treatment electrode can be moved in a single pass across the internal surface. In some embodiments, the electrochemical treatment electrode is moved in at least two passes across the internal surface of the metallic article, preferably multiple passes, to electrochemically treat the internal surface to the desired degree and/or property. Here, movement of the electrochemical treatment electrode across the internal surface may include being pulled back across the internal surface in the reverse direction to the preceding movement during each pass. This produces a cyclical movement across the internal surface to progressively electrochemically treat that surface.

In many embodiments, this movement can be actuated or driven using a suitable draw apparatus for driving movement of electrochemical treatment electrode over the internal surface of the metallic article. In some embodiments, the method further comprises the step of: connecting the electrochemical treatment electrode to a winch or other linear actuator to control the speed of movement of the electrochemical treatment electrode over the internal surface. This enables a uniformed surface treatment/surface finish to be achieved. Here, a controlled draw method is used using stepper motors or linear actuators to make sure each section of channel is affected with the same amount of current for the same amount of time.

The power source or generator typically includes a suitable DC or pulsed power supply (voltage or current controlled) is used to polarise both electrodes (i.e. the cathode/electrochemical treatment electrode and the anode/metallic article). In some embodiments, the power source comprises a DC or a pulsed voltage or current controlled power supply.

Where the apparatus is used for electropolishing a surface, the electrochemical treatment current can be applied in a current regime comprising:
at least one electropolishing regime, each electropolishing regime comprising a current density of at least 2 A/cm² and a voltage comprising a shaped waveform having a frequency from 2 Hz to 300 kHz, a minimum voltage of at least 0 V and a maximum voltage of between 0.5 to 500 V.

Again, when the method of the present invention is used for electropolishing, the method works well with the electropolishing system of the Applicant taught in International Patent Publication No. WO2020/206492. Using this electropolishing/finishing method, accurate prediction of particle removal can be written into the electropolishing steps/program together with reliable repeatability of process.

As discussed for the second aspect of the present invention, the electrochemical treatment fluid can be any suitable fluid used in the particular electrochemical treatment process. For example, for electropolishing an electropolishing electrolyte can be used, and that can comprise any suitable conductive liquid. It should be appreciated that the electrochemical treatment fluid composition, features and selection discussed in relation to that second aspect equally apply to this third aspect of the present invention.

For electropolishing applications, the pH of the electropolishing electrolyte can be between 1 and 14 depending on its composition. In some embodiments, the pH of the electropolishing electrolyte during the electropolishing method of the present invention is preferably between 1.0 to 7.0, more preferably between 1.0 to 3.0. In one embodiment, the pH of the electropolishing electrolyte is around 1.5.

The electropolishing electrolyte temperature should be maintained from-25 to 350° C., preferably from 0 to 150° C., more preferably 50 to 100° C., and yet more preferably 60 to 90° C. Again, the electropolishing electrolyte temperature dependent on the composition of the electropolishing electrolyte. For example, as you get up to 85% phosphoric solution the electropolishing electrolyte is viscous. Thus, the higher the temperature of the electropolishing electrolyte, the better the electrolyte works. Conduction is better at lower concentration, but the resulting lustre of the resulting metallic article is not as good. It should also be appreciated that current density is temperature dependent and varies based on the concentration and composition of the electropolishing electrolyte and therefore the temperature.

In order to maintain the treatment temperature range, cooling methods are normally required. The metallic article may be cooled through various methods including but not limited to heat sink, gas flow or liquid flow cooling. The electrochemical treatment fluid, for example an electropolishing electrolyte, is preferably maintained at a temperature of between 50 to 100° C., more preferably 60 to 90° C. typically by electrolyte flow to or through a heat exchanger. In some embodiments, a convective cooling means, such as a fan, directed to the electrochemical treatment fluid could be used. However, in preferred embodiments, a heat exchanger can be immersed in the electrochemical treatment fluid. For example, in a small scale (laboratory or development scale) this may comprise a water/ice water bath in which a beaker containing electrodes and electropolishing electrolyte is immersed. In a large scale (i.e. commercial/industrial process) this may comprise re-circulation of the electrochemical treatment fluid and cooling thereof by means of a suitable cooling/heat exchange unit. Additionally, one or more filters may be used to collect metal/metal oxide debris from the electropolishing electrolyte.

In embodiments, the electrochemical treatment fluid is fed in an amount that wets the electrochemical treatment electrode. In this respect, the electrode and/or internal surface of the metal article being treated is not fully immersed within the electrochemical treatment fluid, but rather is wetted to the extent that it spreads the electrochemical treatment fluid over the internal surface of the metallic article. The electrode and associated method of electrochemically treating an internal surface of a metallic article therefore does not necessarily require full immersion of the electrochemical treatment electrode and treatment surface within electrochemical treatment fluid to operate. A lesser amount of electrochemical treatment fluid can be fed to the electrochemical treatment electrode which wets the electrode, sufficient to spread over the internal surface of the metal article is sufficient for operation. In comparison, it is noted that most prior art arrangements require electrochemical treatment fluid submersion or full channel electrochemical treatment fluid (electrolyte) filling.

A post electrochemical treatment chemical wash may be required to remove any loose material compounds lying above the metallic surface, and, if applicable, to allow the natural passive layer to reform around the metal alloy.

The electrochemical treatment method of the present invention can be conducted in a conventional electrochemical treatment cell where the metallic article is immersed in the electrochemical treatment fluid, or in non-immersed techniques, for example brush applied electrochemical treatment techniques.

In some embodiments, the electrochemical treatment fluid is contained in an electrochemical treatment cell. For electropolishing applications, the metallic article is immersed in an electropolishing electrolyte and electropolishing takes place within the confines of the electrolyte and receptacle/container which holds the electropolishing electrolyte. In this type of conventional electropolishing the metallic article is connected to the positive terminal of a power supply thereby becoming an anode, in the electrolyte bath. The electropolishing electrode of the first aspect of the present invention is the cathode and is connected to the negative terminal of the power supply thereby becoming the cathode for ionic conduction. That electropolishing electrode is drawn through the internal cavity as described above.

In submerged electropolishing or surface finishing the current densities used in the method of the present invention can be selected based on the equipment and application.

In other embodiments, the electrochemical treatment fluid is applied as a fluid flow onto/over the internal surface of the metallic article. For electropolishing, this technique is known as a non-submerged electropolishing, and generally involve a flow of electropolishing electrolyte being applied to the subject internal surface, of the metallic article, for example through a conduit with an outlet proximate the electrode and a conducting electropolishing electrode being immersed in the electropolishing electrolyte and moving across the surface to electropolish the surface surrounding the conducting electrode.

In this non-submerged method, the metallic article is connected to the positive terminal of a power supply thereby becoming an anode. A cathode comprising the electropolishing electrode of the first aspect of the present invention is connected to the negative terminal of the power supply. The electropolishing electrode is configured as detailed above and is engaged with a selected portion of the internal surface of the metallic article.

In use, electrolyte is fed (typically pumped from a reservoir) to the selected portion of the surface of the metallic article to immerse part of the cathode and surface of the metallic article and therefore form an electropolishing cell on the surface of the metallic article. Coolant can be supplied to cool the electropolishing area. Examples of this electropolishing technique are taught in patent publications No. WO2009/105802, AU2013242795A1 and AU2017204328A1 the contents of which should be considered to be incorporated into this specification by this reference.

In non-submerged electropolishing or surface finishing, the current densities used in the method of the present invention can be selected based on the equipment and application.

It should be appreciated that the size of the metallic article (part size) and apparatus treated by the method of the present invention is scalable as the applied current regime and be applied using a control system that can run multiple inverter power banks in parallel to achieve the desired output current/current density. The method of the present invention can therefore be equally applied to electrochemically treat a part the size of a golf ball and also a part the size of a car by scaling up the size of the electrochemical treatment apparatus and the inverter for applying the applied current regime.

A fourth aspect of the present invention provides an electrochemical treatment electrode configured to contact an internal surface of metallic article with an electrochemical treatment fluid, the electrode comprising:
a flexible conducting body; and
a plurality of flexible elements connected to and extending generally outwardly of the flexible conducting body which are configured to locate an electrochemical treatment fluid around the flexible conducting body,
wherein the flexible elements include at least one flexible sheet or body; or
the electrode further comprises at least one flexible sheet or body, connected to the flexible conducting body preferably extending from, or positioned proximate to, between and/or around the plurality of flexible elements.

In this fourth aspect embodiment, the electrode comprises a flexible conducting body, on or to which the flexible elements are connected and extend. The flexible elements the flexible elements include at least one flexible sheet or body; or the electrode further comprises at least one flexible sheet or body, connected to the flexible conducting body preferably extending from, or positioned proximate to, between and/or around the plurality of flexible elements. It should be appreciated that the above disclosure of features of the invention in relation to the first aspect of the present invention equally applies to this fourth aspect of the present invention.

The flexible sheet or body is typically formed with, positioned proximate to, within, and/or surrounded by the flexible elements and acts as both an additional conductor and in some instances an adsorbent body for carrying any electrochemical treatment fluid such as an electrolyte used in the electrochemical treatment procedure. Any suitable flexible sheet or body can be used, for example one or more foam, sponge or fabric material. Where the flexible sheet/body comprises a foam, any suitable foam can be used, for example a natural or polymer foam. In embodiments, the foam comprises a high temperature foam, such as Intek® PFI-1120 high-temperature foam. Similarly, any suitable fabric material can be used, including woven, unwoven material. In embodiments the fabric comprises a high temperature fabric, such as a fibreglass based fabric, carbon fibre based fabric, or ZOPIN 1.0 g/cm³. The flexible sheet is used to carry electrochemical treatment fluid and can be preferably conductive to assist in the electrochemical treatment of said internal surface of the metallic article depending on the metal to be treated. For example, the flexible sheet can be conductive for nickel alloys. In other embodiments, the flexible sheet can be non-conductive, for example for aluminium alloys. In one embodiment, the flexible sheet or body comprises a foam element configured extend over and surrounding the electrode and plurality of flexible elements. The foam element preferably comprises a sheath or other encompassing body that extends around the electrode and plurality of flexible elements. The plurality of flexible elements can preferably extend into the foam material, thereby providing an electrically conductive path/element within the foam material. However, it should be appreciated that the flexible sheet or body could be configured extend over and surround the electrode using various other means that could connect or otherwise locate the flexible sheet or body around the flexible conducting body.

A fifth aspect of the present invention provides an apparatus for electrochemically treating an internal surface of a metallic article comprising:
at least one electrochemical treatment electrode according to the fourth aspect of the present invention;
an electrochemical treatment fluid source configured to provide electrochemical treatment fluid to the flexible elements of the electrode and onto the internal surface of metallic article; and
a power source,
wherein the electrochemical treatment electrode is connected to a terminal of the power source and the metallic article is connected to the opposite terminal of the power source.

It should be appreciated that the above disclosure of features of the invention in relation to the second aspect of the present invention equally applies to this fifth aspect of the present invention.

A sixth aspect of the present invention provides method of electrochemically treating an internal surface of a metallic article comprising:
electrically connecting the electrochemical treatment electrode according to the fourth aspect of the present invention to a terminal of a power source;
electrically connecting the metallic article to the opposite terminal of the power source;
contacting at least the internal surface of metallic article with an electrochemical treatment fluid, preferably an electrolyte; and
moving the electrochemical treatment electrode across the internal surface of the metallic article whilst an electrochemical treatment current is applied between the terminals of the power source, wherein at least a portion of the plurality of conductive or non-conductive fibres contact the internal surface of the metallic article,
thereby electrochemically treating the internal surface.

It should be appreciated that the above disclosure of features of the invention in relation to the third aspect of the present invention equally applies to this sixth aspect of the present invention.

### BRIEF DESCRIPTION OF THE DRAWINGS

The present invention will now be described with reference to the figures of the accompanying drawings, which illustrate particular preferred embodiments of the present invention, wherein:

FIG. 1 provides a front view of an electrochemical treatment electrode according to one embodiment of the present invention.

FIG. 2 provides perspective view of the electrochemical treatment electrode illustrated in FIG. 1.

FIG. 3A provides a front view of an electrochemical treatment electrode according to one embodiment of the present invention that includes a mixture of flexible fibres.

FIG. 3B provides a first detailed view of circle A of FIG. 3A showing a mixed carbon fibre and Kevlar fibre embodiment of the electrochemical treatment electrode.

FIG. 3C provides a front view of an electrochemical treatment electrode according to another embodiment of the present invention that includes a mixture of flexible fibres.

FIG. 3D provides a second detailed view of circle A1 of FIG. 3C showing a mixed carbon fibre and fiber glass embodiment of the electrochemical treatment electrode.

FIG. 4A provides a perspective view and FIG. 4B provides a front view of an electrochemical treatment electrode according to one embodiment of the present invention that includes a spring-based fibre connector.

FIG. 4C provides a detailed view of circle B of FIG. 4B showing a mixed carbon fibre, Kevlar and fiber glass embodiment of the electrochemical treatment electrode.

FIG. 5A provides a perspective view of an electrochemical treatment electrode according to one embodiment of the present invention that includes a flexible sponge sheath.

FIG. 5B provides a detailed view of circle C of FIG. 5A.

FIG. 6A provides a perspective view of an electrochemical treatment electrode according to one embodiment of the present invention that includes a flexible fibreglass sheet including aluminium wire.

FIG. 6B provides a detailed view of the electrochemical treatment electrode along section D-D of FIG. 6A.

FIGS. 7A and 7B illustrate a spherically shaped electrochemical treatment electrode according to one embodiment of the present invention.

FIG. 8 provides a schematic of an electrochemical treatment apparatus that includes the electrochemical treatment electrode illustrated in one of FIGS. 1 to 4C.

FIG. 9 illustrates a schematic of an immersion electrochemical treatment apparatus that includes an electrochemical treatment electrode as illustrated in one of FIGS. 1 to 4C.

FIG. 10 illustrates a schematic of a non-submerged electrochemical treatment apparatus that includes an electrochemical treatment electrode as illustrated in one of FIGS. 1 to 4C.

### DETAILED DESCRIPTION

The present invention provides an electrode, associated electrochemical treatment system and method which can be used to electrochemically treat the internal surfaces of cavities, hollows, channels or apertures therein within additively manufactured (3D printed) metallic articles or products such as heat exchangers, engine parts or the like.

The electrochemical treatment of the present invention can be any electrochemical process in which a power supply (AC or DC) is used to treat a surface. Suitable electrochemical treatment processes include electropolishing, electro cleaning, anodising, Parkerizing and pickling. However, the following material is exemplified in the context of an electropolishing application. It should be understood that the present invention is not limited to that application and could be applied to various electrochemical treatment processes.

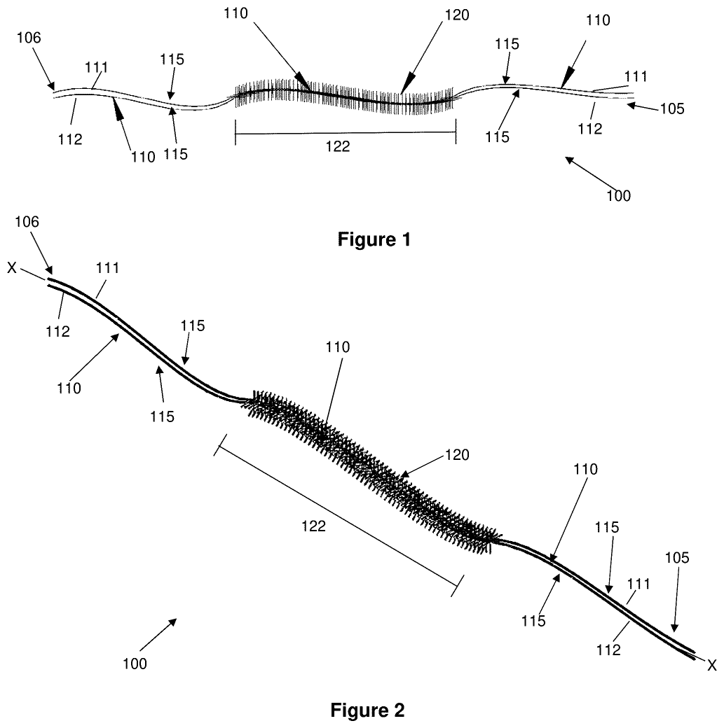

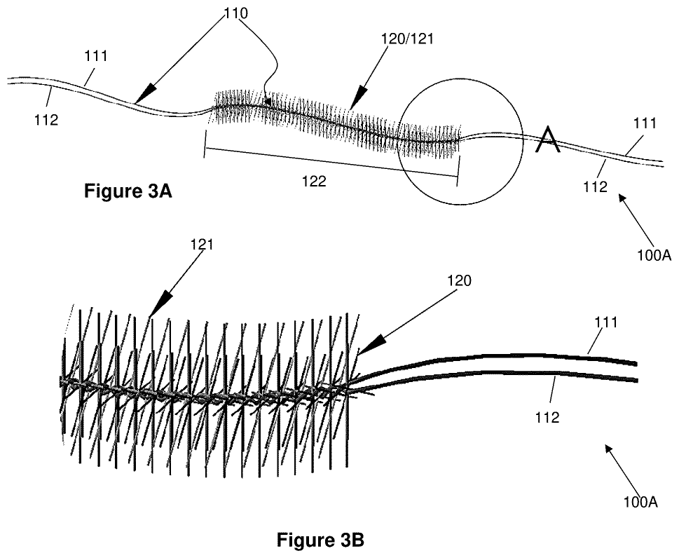

FIGS. 1 and 2 illustrate an electrochemical treatment electrode 100 according to one embodiment of the present invention. As illustrated, the electrochemical treatment electrode 100 comprises two main sections:
(1) a flexible conducting body 110 formed from two elongate strands of flexible conductive wire 111, 112, for example partially stripped magnet wire or similar; and
(2) multiple flexible elements 120 connected to and extending generally radially outwardly of the flexible conducting body 110. In the illustrated embodiment, the flexible elements 120 comprise carbon fibre bristles or strands that directly contact the conductive surface of the flexible conductive wires 111, 112 in the connection zone 122. However, as explained below, the flexible elements can be any suitable flexible fibre and can comprise and/or be intermixed with non-conducting fibres.

Each carbon fibre bristle is secured in position within the connection zone 122 by being placed in between the two elongate strands of flexible conductive wire 111, 112 and then those wires twisted around the carbon fibre bristles to clamp or otherwise compressively engage the carbon fibre bristles between the flexible conductive wires 111, 112. Thus, in this conductive fibre embodiment, an electrical current can therefore flow through the flexible conducting body 110, through the connection zone 122 and through the plurality of flexible elements 120, to the application surface and through the metallic article being electrochemically treated to facilitate electrochemical treatment of the internal surface of that metallic article (as set out below).

The flexible conducting body 110 also function to locate an electrochemical treatment fluid around the flexible conducting body. In this embodiment, the use of multiple bristles closely spaced together provides adjoining elements and surface area to retain the electrochemical treatment fluid, such as an electrolyte, around the conductive body 110 when within the hollow, channel or aperture within the metallic article being electrochemically treated. Here the plurality of bristles forms a flexible brush onto and into which the electrochemical treatment fluid through fluid interactions, typically viscous fluid interactions with those bristles.

The dimensions of the flexible elements 120 are typically configured to suit the dimensions of the channel or duct of the metallic article that is subject to electrochemical treatment, with the length of the flexible elements 120 is typically similar to or slightly larger than the radius of the channel or duct. The flexible elements 120 are designed to be flexible enough to resiliently deform so that the electrode 100 can be inserted into and moved through cavities, hollows, channels or apertures within metallic articles. The illustrated flexible elements 120 comprise carbon fibre bristles having a length of 22 mm along the unidirectional plane and a strip 200 mm long adjacent to the unidirectional plane. However, it should be appreciated that any suitable conductive and preferably resilient flexible strip, filament, whisker, fibre or the like could be used. For example, the flexible elements 120 could also comprise a plurality of carbon fiber fibres, metallic fibres or a mixture of different types of conductive and resilient fibres.

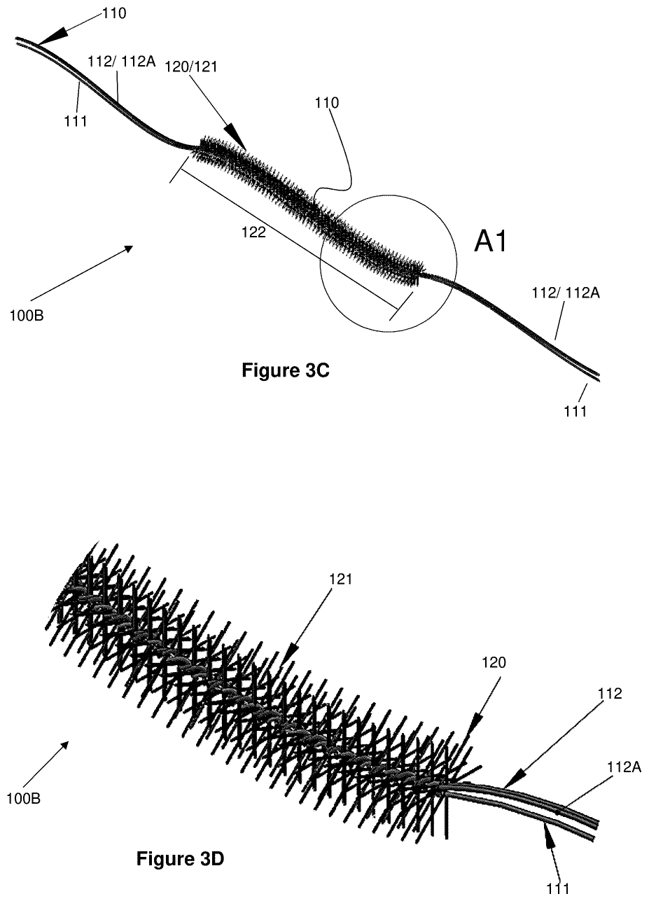

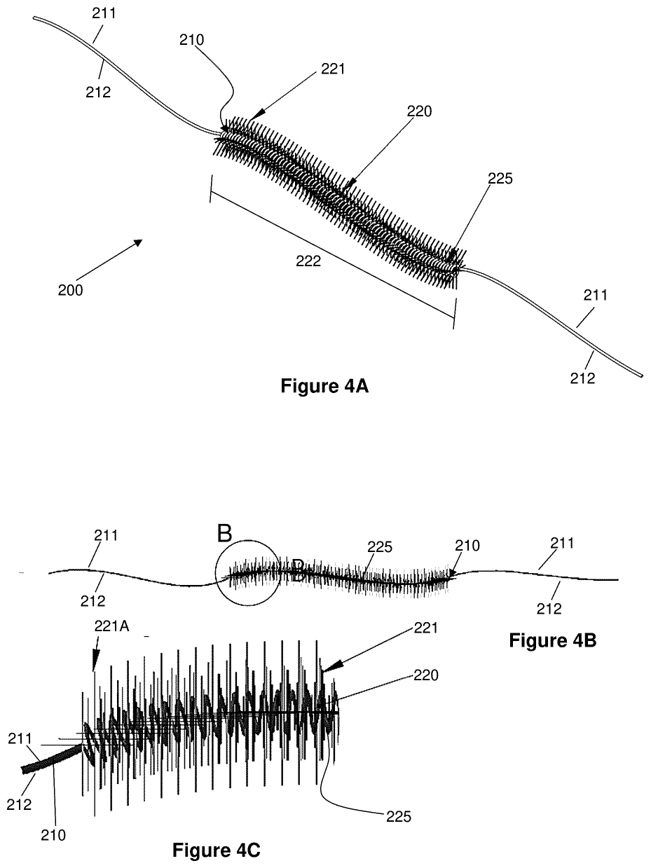

As illustrated in FIGS. 3A to 3D, some embodiments further include a plurality of non-conductive fibres 121 intermixed with the conductive flexible elements 120 (for example carbon fibre) and extending generally radially outwardly of the flexible conducting body 110. Examples of non-conductive fibres 121 include fiberglass as illustrated in FIGS. 3C and 3D, polyparaphenylene terephthalamide (Kevlar) as illustrated in FIG. 3B or a mixture of polyparaphenylene terephthalamide (Kevlar) and fiberglass as illustrated in FIG. 4C. It should however be appreciated that any suitable high temperature non-conducting fibre could be used. The non-conductive fibres 121 are secured in position within the connection zone 122 using the same connection arrangement as the conductive fibres 120. For example, in FIGS. 3B and 3D the non-conductive fibres 121 are held between the wire twists of the two elongate strands of flexible conductive wire 111, 112. In FIG. 4B, the non-conductive fibres 121 are held between the turns of the spring conductive body 125.

It should be noted that in FIGS. 3B and 3D, the carbon fibre strands 120, have a shorter length than the non-conductive fibres 121 (fibre glass fibres in FIG. 3D and Kevlar in FIG. 3B). The longer non-conductive fibres ensure that the shorter conductive carbon fibres are suitable spaced away from the surface to be electrochemically treated to reduce spark or other high voltage release type events.

The flexible conducting body 110 illustrated in FIGS. 1 and 2 comprises two elongate flexible wires 111, 112 that defines a longitudinal axis X-X along the length thereof. The plurality of flexible elements 120 are therefore electrically connected to and extend generally radially outwardly of the longitudinal axis X-X of the flexible conducting body 110. Again, any suitable conductive wire could be used, for example a metallic wire such as stainless steel, gold, copper, aluminium or any other metal or conductive material which exhibits good conductivity and corrosion resistance. In the FIGS. 1 and 2, the elongate flexible wires 111, 112 comprise magnet wire, for example Beldsol dual insulated Magnet Wire (available from Belden Cable), which combines excellent dielectric characteristics of polyurethane and toughness and solvent resistance of a nylon overcoat.

Each flexible wires 111, 112 includes an insulative coating or sleeve 115 over non-electrically connected surfaces. This insulative coating or sleeve 115 may comprises a dielectric coating for example as a polymer coating such as an enamel or a urethane coating. Exemplary coatings include 4228 Red Insulating varnish, CRC Urethane seal coat. It should be appreciated that where the flexible conducting body 110, for example a metallic wire, is supplied with an insulative coating or sleeve 115, that coating can be partially removed (unsheathed etc) in the connection zone 122 to expose the conductive material of that conductive body in the connection zone 122, to facilitate electrical contact and connection between the flexible conducting body 110 and the plurality of flexible elements 120.

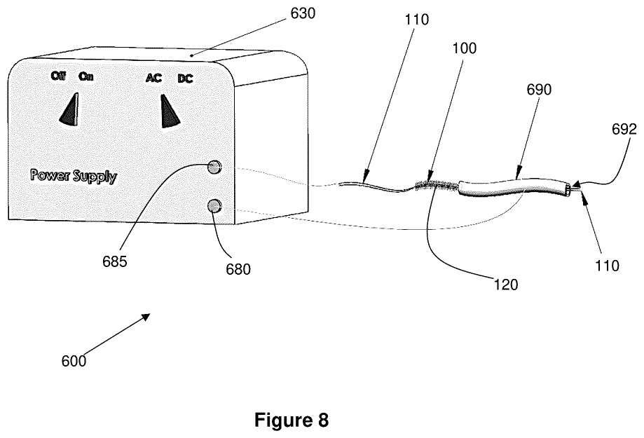

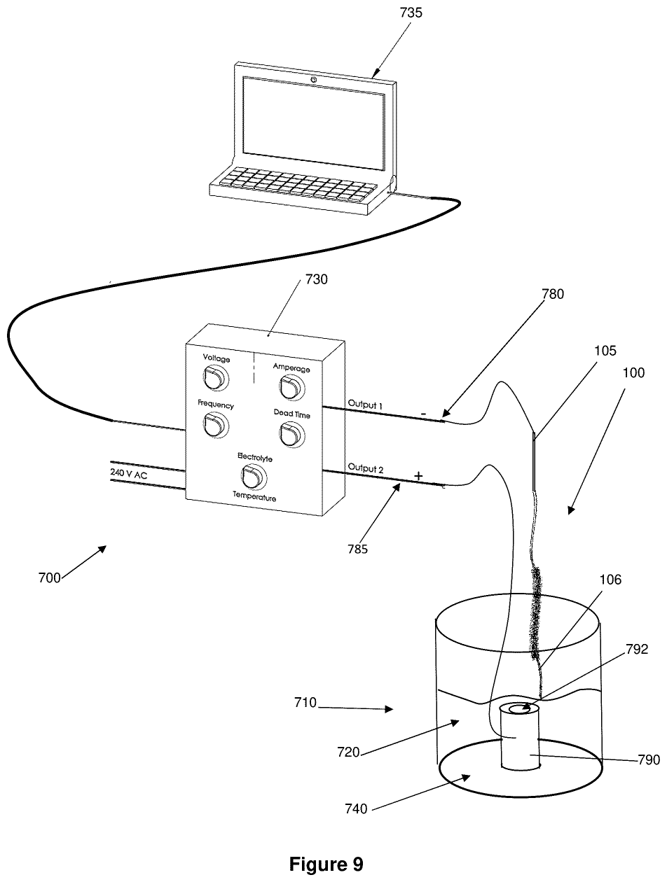

The flexible conducting body 110 has sufficient length so that the ends can be connected to a suitable electrical terminal (cathode) of the power supply of an electropolishing apparatus (as illustrated in FIGS. 8 and 9—described below) and also extend through the required cavity, hollow, channel or aperture of a metallic article. As shown in FIGS. 3C and 3D, more than two flexible elements can also be used to conduct electricity from the power source and electrically connect and secure the flexible elements 120 and non-conductive fibres 121. Here, three sets of flexible wires 111, 112 and 112A are used.

Whilst the illustrated embodiment shows the flexible elements 120 being connected to the flexible conducting body 110 through compressive engagement through twisting the flexible conductive wire 111, 112, it should be appreciated that this conductive connection could be made by various other suitable means. For example, the flexible elements 120 may be connected to the flexible conducting body through weaving, adhesion, welding, embedding, wedging, implanting, bonded, anchoring or a combination thereof. In particular embodiments, the plurality of flexible elements 120 are clamped, crimped, pressed or tied into connection with the flexible conducting body 110. In yet other embodiments, the plurality of flexible elements 120 are pressed, crimped, soldered, welded or glued to the flexible conducting body 110.

FIGS. 4A, 4B and 4C illustrate an embodiment of the electrode 200 where the flexible elements 220 are held in a spring. Here, the connection zone 220 of the elongate flexible conducting body 210 comprises at least one extension spring 225. The extension spring 225 extends through the connection zone 220 and is electrically connected to flexible wires 211, 212 which extend to the power source (not illustrated), as described for the embodiment illustrated in FIG. 1. The flexible elements 220 are connected to the flexible conducting body through compressive engagement between adjacent coils of the spring 225. In the illustrated embodiment, the flexible elements 220 comprise carbon fibre which are intermixed with a mixture of polyparaphenylene terephthalamide (Kevlar) and fiberglass, which are also connected to the flexible conducting body through compressive engagement between adjacent coils of the spring 225.

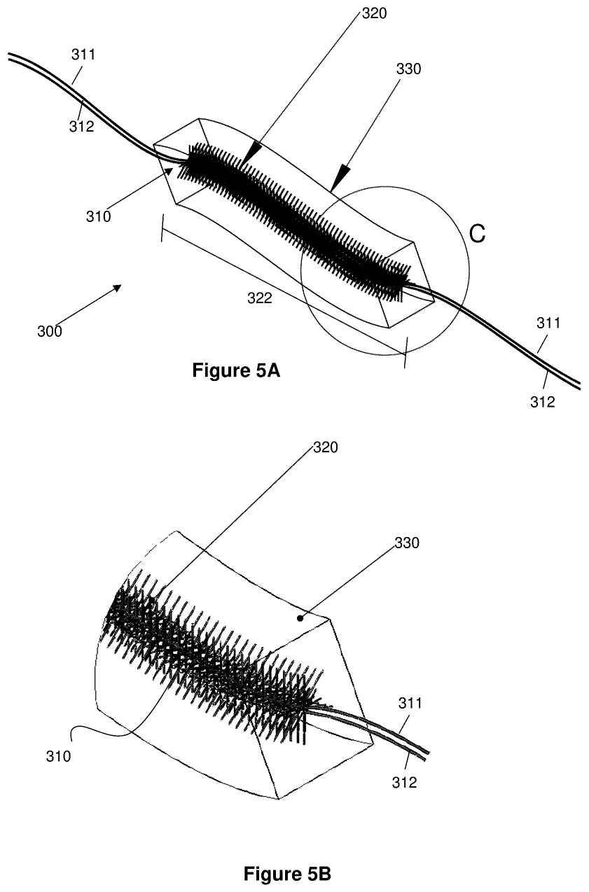

FIGS. 5A to 7B illustrate further and/or alternate embodiments of the electrode of the present invention.

FIGS. 5A and 5B illustrates an embodiment of the electrode 300 that further comprises at least one flexible sheet or body in the form of a foam sheath 330 that is connected to the flexible conducting body 310 through the plurality of flexible elements 320. The foam sheath 330 forms a flexible body that is positioned around and encloses the connection zone 322. As shown in FIG. 5B, the flexible elements are embedded in the foam sheath 330, to enable electrical current to be transferred into the foam sheath 330 from the flexible conducting body 310. In most embodiments, the foam sheath 330 provides an adsorbent body for carrying any electrochemical treatment fluid, such as electropolishing electrolyte used in an electropolishing procedure. Again, that electrochemical treatment fluid is typically a conductive fluid. Any suitable foam material can be used, for example a natural or polymer foam or sponge. In embodiments the foam comprises a high temperature foam, such as Intek® PFI-1120 high-temperature foam (available from Trelleborg Applied Technologies). In the illustrated embodiment, the flexible elements 320 comprise carbon fibre which are connected to the flexible conducting body 310 through compressive engagement through twisting the flexible conductive wire 311, 312 as previously described for other embodiments. Here the flexible elements hold the foam sheath 330 in place, and if conductive, for example comprising carbon fibre or a metallic element, assist flow of current from the flexible conducting body 310 through the electrochemical treatment fluid filled/containing foam sheath 330 and onto the surface which is being electrochemically treated. However, it should be appreciated that this conductive connection could be made by various other suitable means as described above. In other embodiments, the foam sheath 330 may be substituted with a fabric material sheath. That fabric sheath could be formed from any suitable fabric including a woven or an unwoven fabric material. Similar to the foam sheath 330, the flexible sheath can be used (wetted etc) to carry electrolyte and can be preferably conductive to assist in the electrochemical treatment of said internal surface of the metallic article.

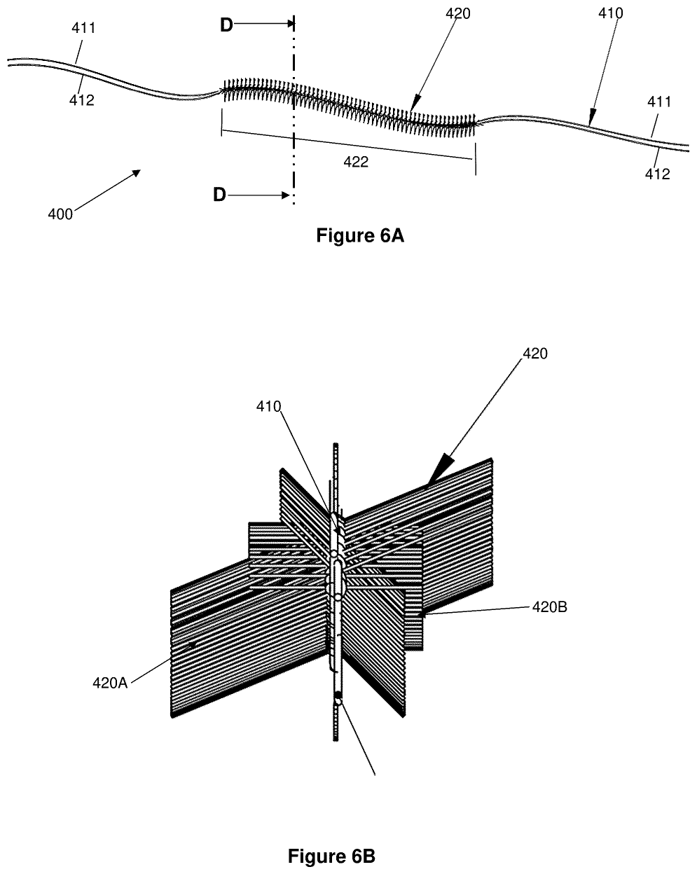

FIGS. 6A and 6B illustrates an embodiment of the electrode 400 that further comprises fibreglass flexible elements 420 which have different length fibreglass fibre lengths in the connection zone 422 around the flexible conducting body 410. The flexible conducting body 410 has a similar configuration to the twisted wire embodiment described in relation to FIG. 1. However, here the radial length of the fibreglass flexible elements 120 vary around the circumference of the conducting body 410. As shown, a first section 420A has a longer length than a second section 420B. That length may be configured to match the shape or configuration of a particular cavity or internal opening that the electrode is configured to electrochemically treat.

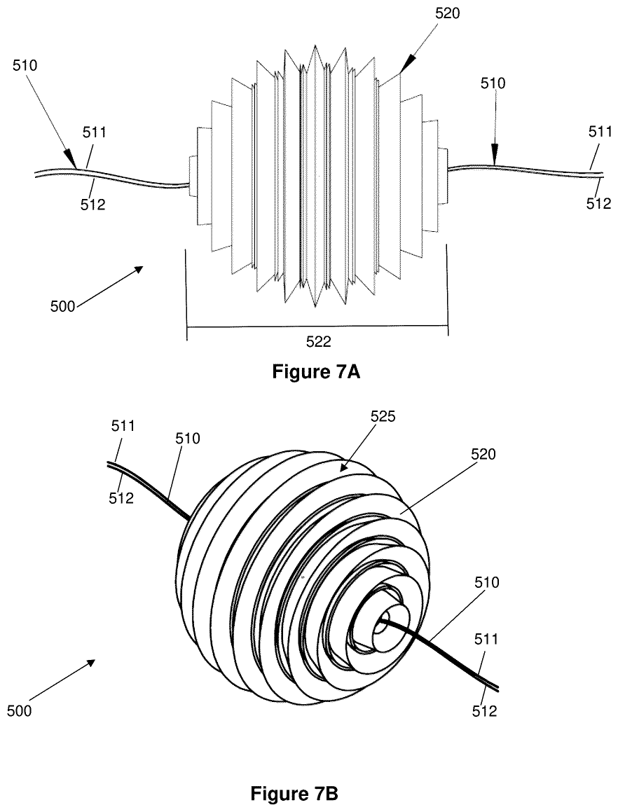

FIGS. 7A and 7B illustrate an embodiment of the electrode 500 that comprises a flexible sphere or ball 525 which includes the plurality of flexible elements 520 that extend from the surface of the ball. In this embodiment, the flexible conducting body 510 comprises flexible wires 511 and 512 which connect to the power source (not illustrated) at one end and to the flexible ball 525 at the opposite end. The flexible ball 525 is formed from a foam core, typically a high temperature foam, that may have some conductive properties. The foam is used to adsorb and hold an electrochemical treatment fluid which can be applied to the surface to be treated. That foam ball includes and/or has attached a series of concentric ribs, strips or flanges which form the flexible elements 520 which extends outwardly from the flexible ball 525. The flexible elements 520 are formed from a carbon fibre blend formed as a moulded shape. The flexible ball 525 may include one or more conductive elements (not illustrated), such as wires or fibres therein to assist in conduction of current from the flexible wires 511 and 512 to the outer surface of the flexible ball. It should be noted that in other embodiments, the flexible ball 525 may include an internal cavity, and thus be hollow, and contain a series of flexible elements, for example conductive elements therein used to retain an electrochemical treatment fluid about a conductive body, for example a wire or spring therein and conduct current from that conductive body to the outer surface of the flexible ball 525. It should be appreciated that foam shape has shape memory so it will hug the internal surface expanding and contracting as it is drawn through varying internal galleries diameters and shapes.

Finally, whilst not illustrated, it should be appreciated that in some embodiments a plurality of conductive particles located proximate to and/or between the plurality of flexible elements. The conductive particles provide an additional conductor means that can mix within the electrolyte to shorten the gap for the electrolyte to the internal surface to be electrochemically treated minimising the resistance of the circuit within the cavity or form a low resistance electrolyte-fibre composite to perform the same duty.

FIG. 8 provides a schematic of a general electrochemical treatment apparatus 600 which can incorporate the electrode 100, 100A, 100B, 200, 300, 400, 500 illustrated in FIGS. 1 to 7C. The illustrated electrochemical treatment apparatus 500 includes an inverter power supply 630 capable of delivering a desired current waveform (DC, DC pulses or variable frequency AC) in short pulses. The inverter power supply 630 can include a computer controller (not illustrated).

The illustrated metallic article 690 includes an internal channel 692 that includes internal surfaces that are required to be electrochemically treated. That metallic article 690 is electrically connected to one terminal 680 of the power supply 630, while the other terminal 685 of the inverter power supply 630 is connected to the electrochemical treatment electrode 100. Electrochemical treatment electrode 100 is illustrated in FIG. 8 as the embodiment described and illustrated in relation to FIG. 1. However, it should be appreciated each of the other embodiments of the electrode 100, 100A, 100B, 200, 300, 400, 500 illustrated in FIGS. 1 to 7C could equally be used. An electrochemical treatment fluid, such as an electrolyte can be applied to the electrode 100 and the metallic article 690 to complete an electrical circuit.

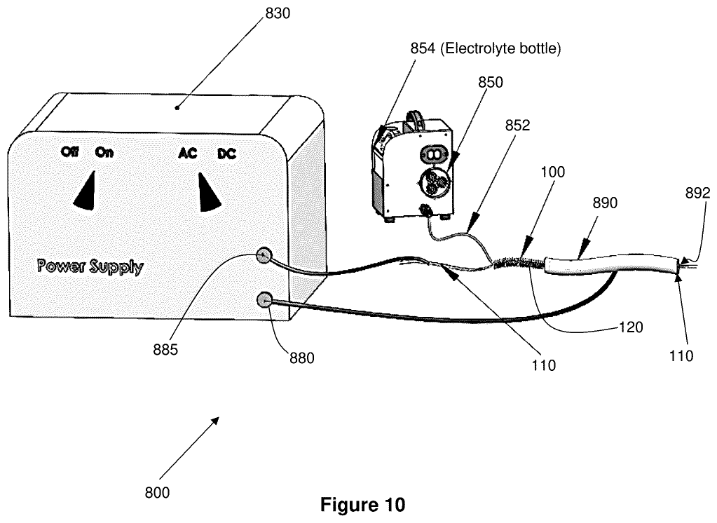

Whilst not explicitly illustrated in FIG. 8, the apparatus 600 also includes an electrochemical treatment fluid on and around the electrode 100 which is provided by an electrochemical treatment fluid source (not illustrated in FIG. 8). That source is configured to provide electrochemical treatment fluid to the flexible elements of the electrode 100 and onto the internal surface of the metallic article 690. The electrochemical treatment fluid source may be a pump system as shown and described below in relation to FIG. 10 or may be an immersion system as described below in relation to FIG. 9. As has been already discussed, he electrochemical treatment fluid is preferably a conductive fluid, for example an electrolyte, which assists in conducting current from the electrode to the surface to be treated to facilitate the desired electrochemical treatment.

The electrochemical treatment process is undertaken by using the power supply 630 to apply current and a voltage difference between the metallic article 690 and the electrode 100 and moving the electrode 100 across that internal surface of the metallic article whilst the current is applied. During this procedure, the internal surface of metallic article 690 is contacted with the electrochemical treatment fluid, such as an electrolyte, to provide good electrical contact and conduction between the electrode 100 and the internal surface of the metallic article 690.

FIG. 9 provides a schematic of a typical electropolishing apparatus 700 which can incorporate the electrode 100, 100A, 100B, 200, 300, 400, 500 illustrated in FIGS. 1 to 7C. The illustrated electropolishing apparatus 700 includes an electrolytic cell 710 having an electrolyte reservoir 720 that is configured to locate an electropolishing electrolyte 740. The electropolishing apparatus 700 also includes an inverter power supply 730 capable of delivering a desired current waveform (DC, DC pulses or variable frequency AC) in short pulses. The inverter power supply 730 is controlled by a computer controller 735.

The illustrated metallic article 790 includes an internal channel 792 that includes internal surfaces that are required to be electropolished. That metallic article 790 is electrically connected to the positive terminal 785 of the inverter power supply 730, while the negative terminal 780 of the inverter power supply 730 is connected to the electropolishing electrode 100 (which acts as a cathode) which also comprises the container containing the electrolyte 7740. The metallic article 190 is suspended in the reservoir 720 in the electrolyte 740 forming a complete electrical circuit with the electropolishing electrolyte 740.

The electrode 100 is illustrated in FIG. 9 as the embodiment described and illustrated in relation to FIG. 1. However, it should be appreciated each of the other embodiments of electrodes 100, 100A, 100B, 200, 300, 400, 500 illustrated in FIGS. 1 to 7C could equally be used.

Whilst not shown, the electropolishing apparatus 710 may also include a mixing device, for example a mixing rotor for stirring/mixing the electropolishing electrolyte 740 and ensuring even distribution of the electrolyte 740 around the metallic article 790 and the electrode 100.

The computer-controlled inverter power supply 730 is used to apply current and a voltage difference between the metallic article 780 and the electrode 100. The computer 735 runs a program that steps the inverter 730 (power source) through an applied current regime comprising a range of voltages/currents and frequencies that have been pre-determined to be optimum for the particular metallic article 790 and the comprising material to be polished. For a given electropolishing electrolyte, the quantity of metal removed from the metallic article is proportional to the amount of current applied and the time. Other factors, such as the geometry of the metallic article, affect the distribution of the current and, consequently, have an important bearing upon the amount of metal removed in local areas.

As noted previously, the electrodes 100, 100A, 100B, 200, 300, 400, 500 illustrated in FIGS. 1 to 7C and the electropolishing system 700 illustrated in FIG. 9 works particularly well using/embodying the electropolishing system of the Applicant taught in International Patent Publication No. WO2020/206492. When used in the electropolishing system of WO2020/206492, the wire can be designed to carry the large currents required and the enamel (wire coating) melting point can be managed by duty cycle and rest/cooling time.

Electropolishing is carried out with the electropolishing electrolyte 540 of the electropolishing apparatus 700 at a temperature in a range of −25° C. to 200° C., and preferably 0 to 150° C. In embodiments, the electropolishing electrolyte 540 is held at a temperature of about 50° C. to 100° C., preferably 60° C. to 90° C. The electropolishing apparatus 700 may also include a combined temperature probe/heating and cooling unit (not illustrated), which can be attached to a computer controller 735 or a separate controller (not illustrated) to monitor and control the temperature of the electropolishing electrolyte 540. In order to maintain the treatment temperature range, cooling methods are normally required. The metallic article 790 may be cooled through various methods including but not limited to heat sink, gas flow or liquid flow cooling. The electropolishing electrolyte is preferably maintained at a temperature of between 50 to 100° C., more preferably 60 to 90° C. typically by electrolyte flow to or through a heat exchanger.

The electropolishing electrolyte 740 preferably comprises a phosphoric acid (H₃PO₄) based solution, typically of 85% concentration diluted with water of a C₁ to C₄ alcohol. However, the electropolishing electrolyte 740 may include other components. For example, in some embodiments the electropolishing electrolyte 740 includes phosphoric acid (H₃PO₄) in combination with sulfuric acid (H₂SO₄), hydrochloric acid (HCl) or combinations thereof, and one of water or a C₁-C₄ alcohol. Other electropolishing electrolyte compositions are also possible. The pH of the electropolishing electrolyte 740 can be between 1 and 14 depending on its composition.

FIG. 10 illustrates a schematic of a non-submerged electrochemical treatment apparatus 800 that includes an electropolishing electrode 100, 100A, 100B, 200 as illustrated in one of FIGS. 1 to 4C. In these embodiments, the electropolishing electrolyte is applied as a fluid flow onto the surface of the metallic article 890 using a pump 850 in which electrolyte is fed from a reservoir (not illustrated) to the electropolishing electrode 100 and metallic article through a feed conduit 852. Such electropolishing techniques are known as non-submerged electropolishing techniques, and generally involve a flow of electropolishing electrolyte being applied to the surface of the metallic article 890, and a conducting electrode 100 being immersed in the electropolishing electrolyte and moving across the surface to electropolish the surface surrounding the conducting electrode 100.

The electrode 100 is illustrated in FIG. 10 as the embodiment described and illustrated in relation to FIG. 1. However, it should be appreciated each of the other embodiments of electrodes 100, 100A, 100B, 200, 300, 400, 500 illustrated in FIGS. 1 to 7C could equally be used.

In this non-submerged method, the metallic article 890 is connected to one terminal 880 of a power supply 830 thereby becoming an anode. The electropolishing electrode 100 shown in FIGS. 1 and 2 is connected to the other terminal 885 of the power supply 830 and acts as a cathode for the electropolishing system 800.

In use, electrolyte is pumped from a reservoir (electrolyte bottle 854) to the selected portion of the surface of the metallic article 890 to immerse part of the electrode 100 and surface of the metallic article 890 and therefore form an electropolishing cell on the surface of the metallic article 890. In some embodiments, coolant can also be supplied to cool the electropolishing area. Again, examples of this electropolishing technique are taught in patent publications No. WO2009/105802, AU2013242795A1 and AU2017204328A1.

In this non-submerged method, the electrolyte can be applied to the internal surface of the subject metallic article by any useful means. As illustrated, the electrolyte is fed onto the internal surface through an electrolyte feed conduit 852 which includes a fluid outlet located within the electrode 100. Typically, the conduit is placed along or in parallel with the flexible wires 111, 112, with an outlet or nozzle (not illustrated) located within the flexible elements 120. This enables the electrolyte to be fed proximate the electrode 100 onto the internal surface of interest. The apparatus 800 may also include a coolant conduit (not illustrated) including at least one fluid outlet located within the electrode 100, and more particularly the flexible elements 120. Again, this enables coolant to be fed proximate the electrode onto the internal surface of interest. The coolant and electrolyte can be pumped using any suitable fluid movement system, such as a pump, syringe, piston or similar.

In each embodiment, the electropolishing electrode 100 can be drawn or otherwise moved through the cavity in the metallic article, to progressively polish the internal surface therein. This movement can be actuated or driven using a suitable draw apparatus such as a linear actuator, winch or similar.

In use, a metallic article 790, 890 can be electropolished using the apparatus illustrated in FIGS. 9 and 10 using the following steps:
1. A terminal end 105 of the flexible conducting body 110 of the electrode 100 is connected to the negative terminal 780, 880 of an electropolishing power source 730, 830, and the draw end 106 of the flexible conducting body 110 can be (where applicable) attached to a suitable draw apparatus (not illustrated).
2. The metallic article 790, 890 is connected to the positive terminal 785, 885 of the electropolishing power source 830, 930.
3. Electrolyte is then applied to the internal surface of the channel 792, 892 of metallic article 790, 890 and the electrode 100 through immersion (using immersion apparatus shown in FIG. 8) or via an electrolyte feed conduit 852 (if using a non-submerged apparatus shown in FIG. 9).
4. The electrode 100 is then moved across the internal surface of the metallic article 790, 890 whilst an electropolishing current is applied between the positive terminal 785, 885 and negative terminal 780, 880. Here, the electrode 100 to be slowly pulled from the draw end 106 of the flexible conducting body 110 through the channel 592 to be polished. If another pass is required, the negative terminal 780, 880 of an electropolishing power source 730, 830 can be connected to the draw end 106 of the flexible conducting body 110 and the electrode 110 is pulled back through the channel 592 in the reverse direction.

The electropolishing electrode 100 can be moved in one or more passes across the internal surface of the metallic article 790, 890, preferably multiple passes, to polish the internal surface to the desired surface roughness. Here, movement of the electropolishing electrode 100 through the channel 592 and across the internal surface may include being pulled back across the internal surface in the reverse direction to the preceding movement during each pass. This produces a cyclical movement across the internal surface to progressively polish that surface.

As discussed above, the flexible elements 120 are preferably sized and configured for the shape and configuration of the internal cavity it is electropolishing. For example, where the internal surface is part of a channel or duct and the length of the flexible elements 120 are selected to have a complementary length to the radial size of the channel or duct.

The electropolishing power source or electropolishing generator 730, 830 typically includes a suitable DC or pulsed power supply (voltage or current controlled) is used to polarise both electrodes (i.e. the cathode/electropolishing electrode and the anode/metallic article). In some embodiments, the electropolishing power source comprises a DC or a pulsed voltage or current controlled power supply.

As previously noted, this electropolishing method works well with the electropolishing system of the Applicant taught in International Patent Publication No. WO2020/206492. Using this electropolishing/finishing method enables accurate prediction of particle removal to be written into the electropolishing steps/program together with providing reliable repeatability of the process.

A post electropolishing chemical wash may be required to remove any loose material compounds lying above the alloy surface, and, if applicable, to allow the natural passive layer to reform around the metal alloy.

The electropolishing electrode, apparatus and method of the present invention can be used to electropolish a variety of metals. Examples of suitable metals include iron and iron containing alloys (such as tool steel H13, Carbon steel (common), stainless steel), aluminium and aluminium containing alloys, titanium and titanium containing alloys, chromium and chromium containing alloys, copper alloys, brass alloys, and/or Niobium. In particular, the present invention can be used to electropolish those metals and metal alloys that have a protective oxide coating. Examples of metals and metal alloys that the electropolishing method can be used on include chromium based metallic alloys, such as stainless steel, nickel-chromium (nickel-chrome), nickel-chrome alloys, cobalt-chromium alloys, cobalt-chromium-molybdenum alloys, and also titanium, titanium alloys, nickel alloys such as nitinol, aluminium or aluminium alloys.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step,

1. An electrochemical treatment electrode configured to contact an internal surface of metallic article with an electrochemical treatment fluid, the electrode comprising:
a flexible conducting body; and
a plurality of flexible elements connected to and extending generally outwardly of the flexible conducting body which are configured to locate an electrochemical treatment fluid around the flexible conducting body,
wherein the plurality of flexible elements includes a plurality of conductive fibres or non-conductive fibres extending generally outwardly of the flexible conducting body, the plurality of conductive fibres or non-conductive fibres configured to contact the internal surface of the metallic article when the electrode is in use.

2. An electrochemical treatment electrode according to claim 1, wherein the flexible elements comprise a plurality of wires, strips, cords, filaments, hairs, spines, fibres, whiskers or bristles.

3. An electrochemical treatment electrode according to claim 1, wherein the flexible elements comprise conductive elements, non-conductive elements, or a mixture thereof.

4. An electrochemical treatment electrode according to claim 1, wherein the plurality of conductive fibres or non-conductive fibres include conductive fibres that comprise at least one of carbon fibres, metallic wire or a mixture thereof.

5. An electrochemical treatment electrode according to claim 1, wherein the plurality of conductive fibres or non-conductive fibres include non-conductive fibres that comprise at least one of fiberglass, polyparaphenylene terephthalamide (Kevlar), or a mixture thereof.

6. An electrochemical treatment electrode according to claim 1, wherein the plurality of flexible elements are connected to the flexible conducting body through compressive engagement, weaving, adhesion, welding, embedding, wedging, implanting, bonded, anchoring or a combination thereof, and optionally wherein the flexible elements are clamped, crimped, pressed or tied into connection with the flexible conducting body.

7. (canceled)

8. An electrochemical treatment electrode according to claim 1, wherein:
the flexible elements include at least one flexible sheet or body; or
the electrode further comprises at least one flexible sheet or body, connected to the flexible conducting body preferably extending from, or positioned proximate to, between and/or around the plurality of flexible elements.

9. An electrochemical treatment electrode according to claim 8, wherein the flexible sheet or body comprises at least one foam, sponge or fabric material, and optionally wherein the flexible sheet of body comprises a foam or sponge configured extend over and surrounding the electrode and plurality of flexible elements.

10. (canceled)

11. An electrochemical treatment electrode according to claim 1, further comprising a plurality of conductive particles located proximate to and/or between the plurality of flexible elements.

12. An electrochemical treatment electrode according to claim 1, wherein the conducting body comprises:
a metallic wire, preferably a magnet wire;
a carbon fibre wire or elongate body; or
a stainless steel, copper, aluminium other conductive metal wire.

13. An electrochemical treatment electrode according to claim 1, wherein the flexible conducting body comprises an elongate flexible conducting body defining a longitudinal axis along the length thereof; and the plurality of flexible elements are connected to and extend generally radially outwardly of the longitudinal axis of the flexible conducting body.

14. An electrochemical treatment electrode according to claim 13, wherein the elongate flexible conducting body comprise at least two elongate wires twisted or otherwise intertwined, and the plurality of flexible elements is connected to the flexible conducting body through compressive engagement between the at least two elongate wires.

15. An electrochemical treatment electrode according to claim 13, wherein the elongate flexible conducting body comprise at least one extension spring, and the flexible elements are connected to the flexible conducting body through compressive engagement between adjacent coils of the spring.

16. (canceled)

17. An electrochemical treatment electrode according to claim 1, wherein the conducting body includes an insulative coating or sleeve over non-electrically connected surfaces, and optionally wherein the insulative coating or sleeve comprises a dielectric coating, preferably a polymer coating, more preferably an enamel or a urethane coating.

18. (canceled)

19. An electrochemical treatment electrode according to claim 1, wherein the conducting body comprises a flexible body, preferably a sphere, ball, rod or pipe which include the flexible elements extending outwardly from the surface of that flexible body, and optionally wherein the flexible body includes an internal cavity, preferably is hollow.

20. (canceled)

21. An apparatus for electrochemically treating an internal surface of a metallic article comprising:
at least one electrochemical treatment electrode according to claim 1;
an electrochemical treatment fluid source configured to provide electrochemical treatment fluid to the flexible elements of the electrode and onto the internal surface of metallic article; and
a power source;
wherein the electrochemical treatment electrode is connected to a terminal of the power source and the metallic article is connected to the opposite terminal of the power source.

22. An apparatus according to claim 21, wherein the electrochemical treatment fluid source comprises a pump which feeds electrochemical treatment fluid to the electrode and onto the internal surface of metallic article.

23. (canceled)

24. (canceled)

25. (canceled)

26. A method of electrochemically treating an internal surface of a metallic article comprising:
electrically connecting the electrochemical treatment electrode according to claim 1 to a terminal of a power source;
electrically connecting the metallic article to the opposite terminal of the power source;
contacting at least the internal surface of metallic article with an electrochemical treatment fluid, preferably an electrolyte; and
moving the electrochemical treatment electrode across the internal surface of the metallic article whilst an electrochemical treatment current is applied between the terminals of the power source, wherein at least a portion of the plurality of conductive or non-conductive fibres contact the internal surface of the metallic article,
thereby electrochemically treating the internal surface.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. An electrochemical treatment electrode configured to contact an internal surface of metallic article with an electrochemical treatment fluid, the electrode comprising:
a flexible conducting body; and
a plurality of flexible elements connected to and extending generally outwardly of the flexible conducting body which are configured to locate an electrochemical treatment fluid around the flexible conducting body,
wherein the flexible elements include at least one flexible sheet or body; or
the electrode further comprises at least one flexible sheet or body, connected to the flexible conducting body preferably extending from, or positioned proximate to, between and/or around the plurality of flexible elements.

40. An electrochemical treatment electrode according to claim 39, wherein the flexible sheet or body comprises at least one foam, sponge or fabric material, and optionally wherein the flexible sheet or body comprises a foam or sponge configured extend over and surrounding the electrode and plurality of flexible elements.

41. (canceled)

42. (canceled)
